(19) United States
(12) Patent Application Publication
(10) Pub. No.: US 2009/0115691 A1
(43) Pub. Date: May 7, 2009

(54) DISPLAY DEVICE

(75) Inventors: Shigenori KATAYAMA, Okaya-shi (JP); Takashi TOYA, Gifu-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/206,312

(22) Filed: Sep. 8, 2008

(30) Foreign Application Priority Data
Nov. 7, 2007 (JP) 2007-289185

(51) Int. Cl. G09G 3/20

(52) U.S. Cl. 345/55

(57) ABSTRACT

There is provided a display device including a plurality of pixels, a plurality of inverting circuits each for generating a second electrical potential by inverting a first electrical potential supplied to a pixel electrode included in the pixel, each of the plurality of inverting circuits being connected to a power source at a high voltage side and a power source at a low voltage side, and a delay circuit for delaying a signal input to the inverting circuit, the delay circuit being provided between the plurality of inverting circuits.

### BACKGROUND

1. Technical Field

The present invention relates to a display device, and in particular, to a display device equipped with an inverting circuit that inverts an electrical potential input to a pixel.

2. Related Art

A display device equipped with an inverting circuit that inverts an electrical potential input to a pixel has been conventionally known (for example, see JP-A-2007-147963 (hereinafter, referred to as Patent Document 1)). In Patent Document 1, a display device is disclosed in which a pixel including a storage element, a transistor for rewriting the storage element, and a transmission gate for supplying data to a pixel electrode is provided, and the pixel is set to an on state or an off state based on the data stored in the storage element. In the display device, an on signal for setting the pixel to an on state is generated by inversing an off signal for setting the pixel to an off state by an inverting circuit. Further, inverting circuits, each constituted by a NOT circuit (inverter), for generating an on signal for setting the pixel to an on state by inverting an off signal for setting the pixel to an off state are provided at four corners outside the display area.

However, in the display device described in Patent Document 1, when an off signal is inverted by one of the inverting circuits disposed at the four corners outside the display area, an n-channel transistor and a p-channel transistor constituting a NOT circuit constituting the inverting circuit become on states at a same time. Accordingly, a through current flows between a power source at a high voltage side and a power source at a low voltage side. Consequently, electrical potentials of the power source at the high voltage side and the power source at the low voltage side to which the plurality of inverting circuits are connected are lowered. Accordingly, there is a disadvantage that malfunctions of the transistor for rewriting the storage element of the pixel and the storage element incorporated in the pixel occurs. As a result, correct data is not supplied to the transmission gate. Accordingly, there is a problem in that an error signal is supplied to the pixel electrode.

### SUMMARY

An advantage of some aspects of the invention is to provide a display device which makes it possible to restrain that an error signal is supplied to a pixel electrode due to lowering of electrical potentials of a power source at a high voltage side and a power source at a low voltage side connected to an inverting circuit,

According to a first aspect of the invention, there is provided a display device including a plurality of pixels, a plurality of inverting circuits each for generating a second electrical potential by inverting a first electrical potential supplied to a pixel electrode included in the pixel, each of the plurality of inverting circuits being connected to a power source at a high voltage side and a power source at a low voltage side, and a delay circuit for delaying a signal input to the inverting circuit, the delay circuit being provided between the plurality of inverting circuits.

In the display device according to the first aspect of the invention, as described above, the delay circuit for delaying a signal input to the inverting circuit is equipped between the plurality of the inverting circuits. Accordingly, signals input to the plurality of the inverting circuits are respectively delayed by the delay circuit, so that it can be restrained that the inverting circuits are operated at the same time. Herewith, unlike the case where a same signal is input to the plurality of inverting circuits at the same time and the inverting circuits are operated at the same time, a through current that momentarily flows between a power source at a high voltage side and a power source at a low voltage side of the inverting circuits can be reduced. As a result, lowering of electrical potentials of the power source at the high voltage side and the power source at the low voltage side of the inverting circuits can be restrained. Accordingly, it can be restrained that an error signal is supplied to the pixel electrode.

It is preferable that each of the first electrical potential and the second electrical potential is a pulse signal in the display device according to the first aspect of the invention. With the structure, a direction of the voltage applied to liquid crystal is switched without inverting data. Accordingly, electric power consumption can be restrained at a low level and burn-in of the liquid crystal can be restrained.

It is preferable that a plurality of the delay circuits are provided, and at least a part of the plurality of delay circuits is formed in an area in which the plurality of pixels are arranged in the display device according to the first aspect of the invention. With the structure, unlike the case where the plurality delay circuits are formed outside the area in which the pixels are arranged, a planner size of the display device can be easily reduced by sizes of the delay circuits formed in the area in which the plurality of pixels are arranged.

In this case, it is preferable that the area in which the plurality of pixels are arranged is a rectangular shape, the plurality of inverting circuits includes four inverting circuits disposed at four corners of the rectangular area in which the plurality of pixels are arranged, and two adjacent inverting circuits among the four inverting circuits are connected via one of the delay circuits formed in the area in which the plurality of pixels are arranged and the other two adjacent inverting circuit among the four inverting circuits are connected via another one of the delay circuits formed in the area in which the plurality of pixels are arranged. With the structure, unlike the case where the inverting circuits are connected via the delay circuit formed outside the area in which the plurality of the pixels are arranged, it can be restrained that a planar size of the display device is enlarged even when the delay circuit is provided.

It is preferable that at least the delay circuit formed in the area in which the plurality of the pixels are arranged among the plurality of delay circuits is constituted by a resistor and a capacitor in the display device in which the delay circuit is formed in the area in which the plurality of the pixels are arranged. With the structure, unlike the case where each of the delay circuits is constituted by, for example, an inverter or the like, the size of the delay circuit can be easily reduced. As a result, the delay circuit can be easily formed in the area in which the plurality of pixels are arranged.

In this case, it is preferable to further include a wiring contained in the delay circuit formed in the area in which the plurality of the pixels are arranged and a data line for supplying data to the pixel, and that a sheet resistance of the wiring is larger than a sheet resistance of the data line. With the structure, delay of a signal output from the delay circuit can be easily performed by the wiring.

It is preferable that a plurality of the delay circuits are provided, and each of the plurality of delay circuits has a same delay amount in the display device according to the first aspect of the invention. With the structure, unlike the case where delay amounts of the delay circuits are varied, the delay amount of the signal input to each of the inverting circuits can be precisely adjusted.

It is preferable that the delay circuit includes an inverter in the display device according to the first aspect of the invention.

It is preferable that the delay circuit includes at least any one of a NAND circuit and a NOR circuit in the display device according to the first aspect of the invention.

It is preferable that a signal input to the inverting circuit is to be input to the pixel electrode and a common electrode of the pixel in the display device according to the first aspect of the invention. With the structure, the structure of the display device can be simplified unlike the case where signals from different power sources are respectively input to the pixel electrode and a common electrode.

It is preferable that the pixel includes a storage element in the display device according to the first aspect of the invention. With the structure, when data for the pixel is not rewritten, consumption current is nearly equal to the current consumed at a standby state of the storage element. Accordingly, it can be restrained that electric power consumption of the display device becomes large.

It is preferable that the inverting circuits and the delay circuit are formed on a substrate on which a semiconductor element constituting the pixel is formed in the display device according to the first aspect of the invention.

According to a second aspect of the invention, there is provided an electronic apparatus including the display device according to the first aspect of the invention. With the structure, an electronic apparatus which makes it possible to restrain that an error signal is supplied to the pixel electrode due to lowering of electrical potentials of a power source at a high voltage side and a power source at a low voltage side connected to the inverting circuit can be obtained.

### BRIEF DESCRIPTION OF THE DRAWINGS

The invention will be described with reference to the accompanying drawings, wherein like numbers reference like elements.

FIG. 1 is a plan view showing a display device according to a first embodiment of the invention.

FIG. 2 is an enlarged view showing a driving circuit and a display area of the display device according to the first embodiment of the invention,

FIG. 3 is a circuit diagram of a pixel according to the first embodiment of the invention.

FIG. 4 is a circuit diagram of a delay circuit according to the first embodiment of the invention.

FIG. 5 is a circuit diagram of an inverting circuit according to the first embodiment of the invention.

FIG. 6 is a circuit diagram of an inverter according to the first embodiment of the invention.

FIG. 7 is a waveform diagram showing a signal F and a signal /F according to the first embodiment of the invention.

FIG. 8 is a diagram showing an example of an electronic apparatus using the display device according to the first embodiment of the invention.

FIG. 9 is a diagram showing an example of an electronic apparatus using the display device according to the first embodiment of the invention.

FIG. 10 is a plan view showing a display device according to a second embodiment of the invention.

FIG. 11 is a circuit diagram of the display device according to the second embodiment of the invention.

FIG. 12 is a plan view showing a display device according to a third embodiment of the invention.

FIG. 13 is a circuit diagram of the display device according to the third embodiment of the invention.

FIG. 14 is a circuit diagram of a delay circuit according to a modification of the first to third embodiments of the invention.

FIG. 15 is a circuit diagram of a delay circuit according to a modification of the first to third embodiments of the invention.

FIG. 16 is a circuit diagram of a delay circuit according to a modification of the first to third embodiments of the invention.

FIG. 17 is a circuit diagram of a delay circuit according to a modification of the first to third embodiments of the invention.

### DESCRIPTION OF EXEMPLARY EMBODIMENTS

Hereinafter, embodiments of the invention will be described with reference to the accompanying drawings.

### First Embodiment

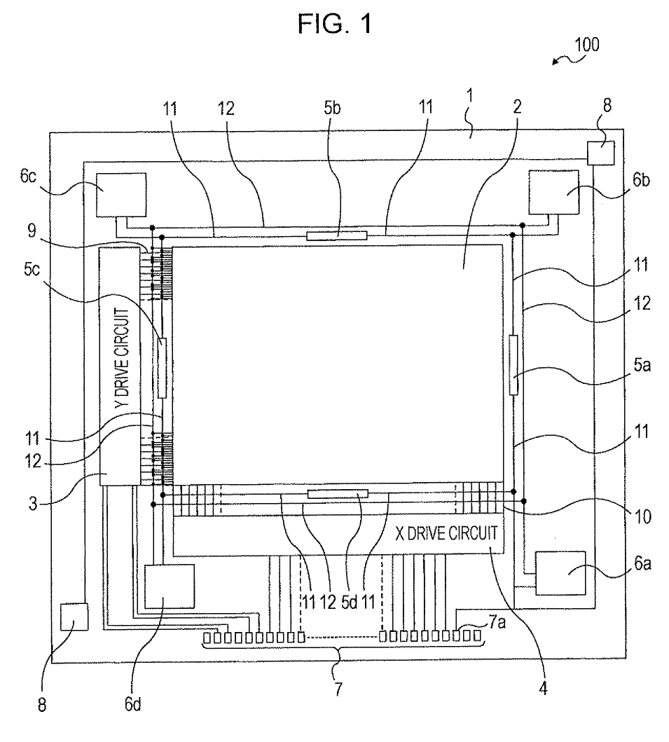

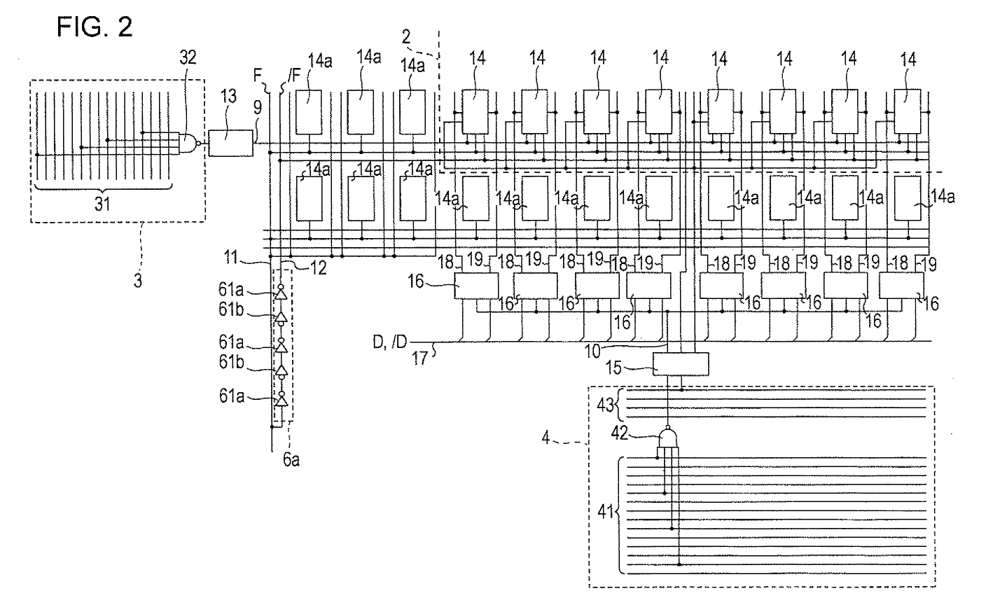

FIG. 1 is a plan view showing a display device according to a first embodiment of the invention. FIGS. 2 to 6 are each a diagram showing a structure of the display device according to the first embodiment of the invention. First, a display device 100 according to the first embodiment of the invention will be described with reference to FIGS. 1 to 6.

The display device 100 according to the first embodiment includes a display area 2, a Y drive circuit 3, an X drive circuit 4, delay circuits 5a to 5d, inverting circuits 6a to 6d, signal input terminals 7, and opposing electrode pads 8 that are formed on a substrate 1. Hereinafter, description will be made in detail.

As shown in FIG. 1, Y gate lines 9 that are connected to the Y drive circuit 3 are disposed and X gate lines 10 that are connected to X drive circuit 4 are disposed in the display area 2 having a rectangular shape in which a plurality of pixels 14 described below are arranged. Further, the inverting circuits 6a to 6d are disposed at four corners of the rectangular display area 2 one by one, Each of the inverting circuits 6a to 6d is connected to a signal line 11 and a signal line 12. Note that a signal whose logic will be inverted by corresponding one of the inverting circuits 6a to 6d is supplied to the signal line 11 and a signal whose logic is inverted by corresponding one of the inverting circuits 6a to 6d is supplied to the signal line 12. Herein, in the first embodiment, the delay circuit 5a is connected to the inverting circuits 6a and 6b via the signal lines 11. Further, the delay circuit 5b is connected to the inverting circuits 6b and 6c via the signal lines 11. Further, the delay circuit 5c is connected to the inverting circuits 6c and 6c via the signal lines 11. Further, the delay circuit 5d is connected to the inverting circuits 6a and 6d via the signal lines 11. Herein, in the first embodiment, each the delay circuits 5a to 5d have a same delay amount. Further, a terminal 7a for inputting a signal to a pixel electrode 148a described below is included in the signal input terminals 7, and the terminal 7a is connected to the inverting circuits 6a and 6d and connected to the delay circuits 5a and 5d. Further the terminal 7a is connected to the opposing electrode pads 8. Further, the signal lines 11 and 12 are respectively connected to the pixel electrode 148a of the pixel 14 via a transmission gate 146 and a transmission gate 147 described below.

Further, as shown in FIG. 2, a plurality of wirings 31 to which a signal of quaternary number is input are provided in the Y drive circuit 3, and four wirings 31 among the plurality of the wirings 31 are connected to input terminals of a NAND circuit 32. Further an output terminal of the NAND circuit 32 is connected to the plurality of pixels 14 and dummy pixels 14a via a buffer 13. Note that three lines of the dummy pixels 14a are arranged along the Y drive circuit 3 and one line of the dummy pixels 14a are arranged along the X drive circuit 4 outside the display area 2.

Further, a plurality of wirings 41 to which a signal of quaternary number is input are provided in the X drive circuit 4. Four wirings 41 among the plurality of wirings 41 are connected to input terminals of a NAND circuit 42. Further, an output terminal of the NAND circuit 42 is connected to an input terminal of a buffer 15. Further, a plurality of wirings 43 to which an output signal from an AND circuit not shown to which a write enable signal and a chip enable signal are input is input are provided in the X drive circuit 4. One wiring 43 among the plurality of wirings 43 is connected to an input terminal of the buffer 15. Further, output terminals of the buffer 15 are connected to the pixel 14 and a sample hold circuit 16.

Further, a data line 17 is input to the sample hold circuit 16. Further, an output signal from the sample hold circuit 16 is input to the pixel 14 via a data line 18 and a data line 19. Note that a signal /D whose logic is inverted with respect to the signal D that is output to the data line 18 is output to the data line 19.

Further, a signal F that is applied to the pixel electrode 148a described below and a signal /F in which a logic of the signal F is inversed by one of the inverting circuits 6a to 6d are respectively input to the pixel 14 from the signal lines 11 and 12. Note that the signal F and the signal /F are examples of the “first electrical potential” and the “second electrical potential” of the invention.

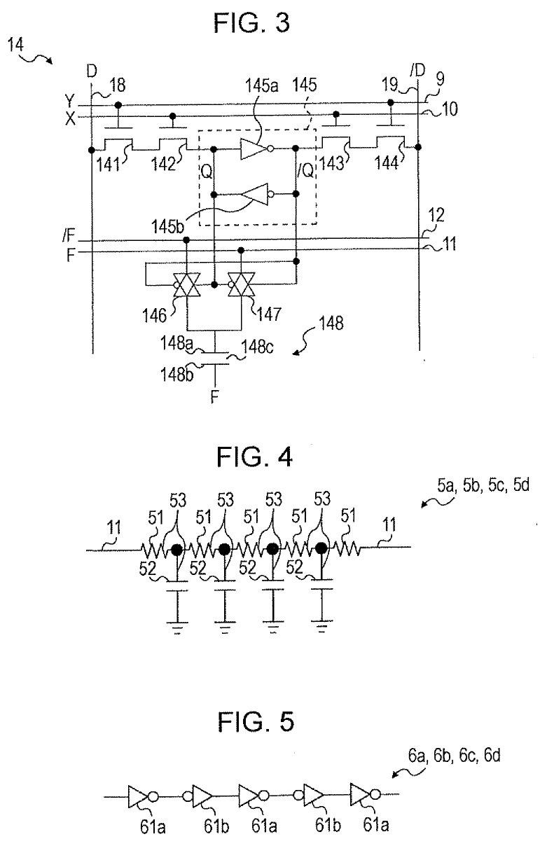

Further, as shown in FIG. 3, the pixel 14 is constituted by transistors 141 to 144, an SRAM 145, a transmission gate 146, a transmission gate 147, and a liquid crystal element 148. Note that the SRAM 145 is an example of the “storage element” of the invention.

Further, the Y gate line 9 to which a signal from the Y drive circuit 3 is input is connected to the gate of the transistor 141, and one of the source/drain of the transistor 141 is connected to the data line 18. Further, one of the source/drain of the transistor 142 is connected to the other one of the source/drain of the transistor 141. Further, the X gate line 10 to which a signal from the x drive circuit 4 is input is connected to the gate of the transistor 142, and the SRAM 145 is connected to the other one of the source/drain of the transistor 142. Further the X gate line 10 to which a signal from the X drive circuit 4 is input is connected to the gate of the transistor 143, and the SRAM 145 is connected to one of the source/drain of the transistor 143. Further, one of the source/drain of the transistor 144 is connected to the other one of the source/drain of the transistor 143. Further, the Y gate line 9 to which a signal from the Y drive circuit 3 is input is connected to the gate of the transistor 144, and the data line 19 is connected to the other of the source/drain of the transistor 144.

The SRAM 145 is constituted by two inverters 145a and 145b. Note that an output signal from the inverter 145a is input to the inverter 145b as an input signal, and an output signal from the inverter 145b is input to the inverter 145a as an input signal.

Further, one of input terminals of the transmission gate 146 is connected to an input side of the inverter 145a and an output side of the inverter 145b, and the other one of the input terminals is connected to the signal line 12 to which the signal /F that makes the pixel 14 to an on state is supplied. Further, one of input terminals of the transmission gate 147 is connected to an output side of the inverter 145a and an input side of the inverter 145b, and the other one of the input terminals is connected to the signal line 11 to which the signal F that makes the pixel 14 to an off state is supplied. Further, output terminals of the transmission gate 146 and the transmission gate 147 are connected to the pixel electrode 148a of the liquid crystal element 148. Herein, the transmission gate 146 electrically connects the signal line 12 and the pixel electrode 148a by being made to an on state when a terminal Q is H level and a terminal /Q is L level. Further, the transmission gate 147 electrically connects the signal line 11 and the pixel electrode 148a by being made to an on state when the terminal Q is L level and the terminal /Q is H level.

Further, the liquid crystal element 148 is constituted by the pixel electrode 148a connected to the transmission gate 146 and the transmission gate 147, a common electrode 148b oppositely disposed to the pixel electrode 148a, and liquid crystal 148c sandwiched between the pixel electrode 148a and the common electrode 148b.

Further, in the first embodiment, the input side and the output side of each of the delay circuits 5a to 5d are connected to the wirings 11 as shown in FIG. 4. Each of the delay circuits 5a to 5d is constituted by five resistors 51 and four capacitors 52. The resistors 51 are connected in series. Further, one of the electrodes of the capacitor 52 is connected to a connecting point of two resistors 51 that are connected in series and the other one of the electrodes of the capacitor 52 is grounded. Further, the resistors 51 and the capacitors 52 of each of the delay circuits 5a to 5d are constituted by a wiring 53, and a sheet resistance of the wiring 53 is larger than sheet resistances of the data line 18 and the data line 19 of the pixel 14.

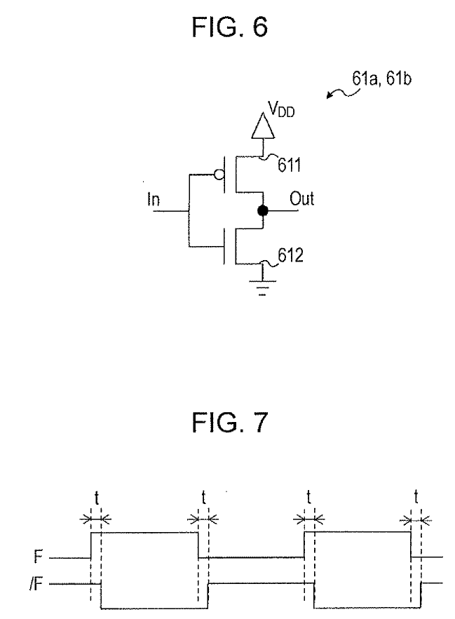

Further, as shown in FIG. 5, each of the inverting circuits 6a to 6d is constituted by alternatively connecting three positive logic inverters 61 and two negative logic inverters 61b. Further, each of the inverter 61a and the inverter 61b is constituted by connecting one of the source/drain of an n channel transistor 612 to one of the source/drain of a p channel transistor 611 as shown in FIG. 6. Further, the other one of the source/drain of the p channel transistor 611 is connected to a power source (V_{DD}) at a high voltage side. Further the other one of the source/drain of the n channel transistor 612 is grounded (GND). Further the gate of the p channel transistor 611 and the gate of the n channel transistor 612 are connected.

FIG. 7 is a waveform diagram showing the signal F and the signal /F according to the first embodiment of the invention. Next, an operation of the display device 100 according to the first embodiment of the invention will be described with reference to FIGS. 1 to 3, and 7.

Firsts in the Y drive circuit 3 shown in FIG. 2, a signal of quaternary number is input to the wirings 31 and the NAND circuit 32 corresponding to a predetermined address is selected. Herewith, each of the transistor 141 and the transistor 144 whose gates are connected to the predetermined Y gate line 9 shown in FIG. 3 is made to an on state.

Next, in the X drive circuit 4 shown in FIG. 2, a signal of quaternary number is input to the wirings 41. Herewith, the NAND circuit 42 corresponding to a predetermined address is selected. Then, an output from the NAND circuit is input to the buffer 15. Further, an output signal from the AND circuit not shown to which a write enable signal and a chip enable signal are input is input to the buffer 15 via the wirings 43. Then an output from the buffer 15 is input to the pixel 14 and input to the sample hold circuit 16. Herewith, each of the transistor 142 and the transistor 143 whose gate is connected to the X gate line 10 shown in FIG. 3 is made to an on state.

Further, as shown in FIG. 2, the signal D and the signal /D from the data line 17 are input to the sample hold circuit 16, and an output from the sample hold circuit 16 is output to the pixel 14. Then, the signal D and the signal /D are respectively stored in the terminal Q and the terminal /Q of the SRAM 145 via the data line 18 and data line 19 shown in FIG. 3.

Further, as shown in FIG. 3, the signal F that is input to the pixel electrode 148a is input to the signal line 11. Herein, in the first embodiment, the signal F is a pulse signal as shown in FIG. 7. Further, a part of the signal F input to the signal line 11 is inverted by one of the inverting circuit 6a to 6d to the signal /F whose logic is inverted, and the signal /F is input to the signal line 12. Herein, in the first embodiment, as shown in FIG. 1, since the delay circuits 5a to 5d are provided between the inverting circuits 6a to 6d, the signal /F output from each of the inverting circuits 6a to 6d is a pulse signal similarly to the signal F, and is delayed by time t than the signal F. Each of the inverting circuits 6a to 6d performs inverting at a different timing due to the delay circuits 5a to 5d and a difference of the length of the wiring from the terminal 7a to each of the inverting circuits 6a to 6d. Herein, in the first embodiment, the signal F which is the same as the signals input to the inverting circuits 6a to 6d is input to the common electrode 148b shown in FIG. 3.

Herein, when the terminal Q is H level, the transmission gate 146 becomes on-state and the transmission gate 147 becomes off-state. Herewith, the signal /F is input to the pixel electrode 148a from the signal line 12. As a result, the signal /F is input to the pixel electrode 148a and the signal F is input to the common electrode 148b. Herewith, the pixel 14 becomes on-state. Further, when the terminal Q is L level, the transmission gate 146 becomes off-state and the transmission gate 147 becomes on-state. As a result, the signal F is input to the pixel electrode 148a and the signal F is also input to the common electrode 148b. Herewith, the pixel 14 becomes off-state.

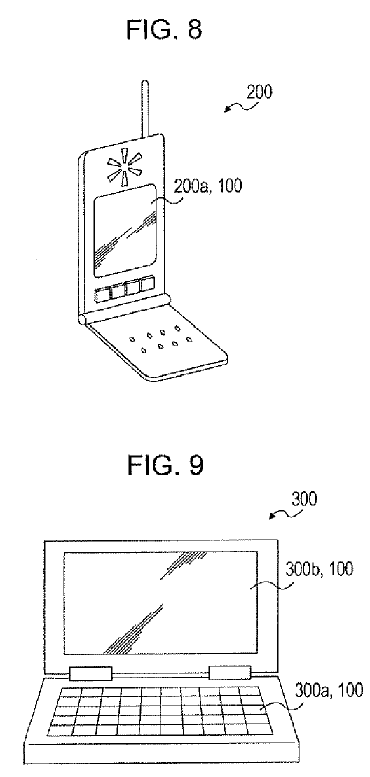

FIGS. 8 and 9 are diagrams illustrating an example and another example of an electronic apparatus using the display device according to the first embodiment of the invention. Next, the electronic apparatuses using the display device 100 according to the first embodiment of the invention will be described with reference to FIGS. 8 and 9.

The display device 100 according to the first embodiment of the invention can be used for a cellular phone 200, a PC (Personal Computer) 300, or the like as shown in FIGS. 8 and 9. The display device 100 according to the first embodiment of the invention is used for a display screen 200a in the cellular phone 200 of FIG. 8. Further, the display device 100 can be used for an input section such as a key board 300a, display screen 300b, or the like in the PC 300 of FIG. 9. Further, when each of the electronic apparatuses is driven by a battery or the like, operating life of the battery can be extended by using a reflective type liquid crystal panel that does not use a light source. Further, by incorporating a peripheral circuit in a substrate in a liquid crystal panel, the number of parts can be largely reduced and weight saving and downsizing of the device main body can be performed.

In the first embodiment, as described above, since the delay circuits 5a to 5d for delaying signals input to the four inverting circuits 6a to 6d are equipped between four inverting circuits 6a to 6d, signals input to the four inverting circuits 6a to 6d are respectively delayed by the four delay circuits 5a to 5d. Accordingly, it can be restrained that the inverting circuits 6a to 6d are operated at a same time. Herewith, a through current that momentarily flows between a power source at a high voltage side and a power source at a low voltage side of the inverting circuits 6a to 6d can be reduced unlike the case where a same signal is input to the four inverting circuits 6a to 6d at a same time and the inverting circuits 6a to 6d are operated at the same time. Herewith, lowering of the electrical potentials of the power source at the high voltage side and the power source at the low voltage side of the inverting circuits 6a to 6d can be restrained. Accordingly, malfunction of the transistors 141 to 144 that rewrite the SRAM 145 and the SRAM 145 contained in the pixel 14 can be restrained. As a result, it can be restrained that an error signal is supplied to the pixel electrode 148a.

In the first embodiment, the signal F and the signal /F are pulse signals as described above. Accordingly, unlike the case where a direct current signal is input to the pixel electrode 148a, the direction of the voltage applied to the liquid crystal 148c is switched. Accordingly, electric power consumption can be restrained at a low level and burn-in of the liquid crystal 148c can be restrained.

Further, in the first embodiment, as described above, delay amounts of the delay circuits 5a to 5d are same. Herewith, unlike the case where delay amounts of the delay circuits 5a to 5d are varied, the delay amount of the signal input to each of the inverting circuits 6a to 6d can be precisely adjusted.

Further, in the first embodiment, as described above, by inputting a signal input to each of the inverting circuits 6a to 6d to the pixel electrode 148a and the common electrode 148b of the pixel 14, the structure of the display device 100 can be simplified unlike the case where signals from different power sources are respectively input to the pixel electrode 148a and the common electrode 148b.

Further, in the first embodiment, as described above, the pixel 14 includes the SRAM 145. Accordingly, when data for the pixel 14 is not rewritten, consumption current is nearly equal to the current consumed at a standby state of the SRAM 145. Accordingly, it can be restrained that electric power consumption of the display device 100 becomes large.

### Second Embodiment

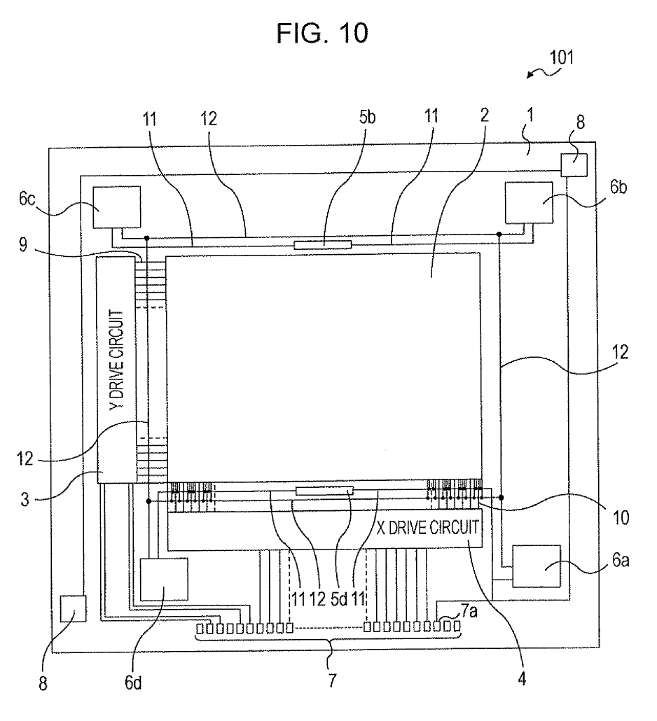

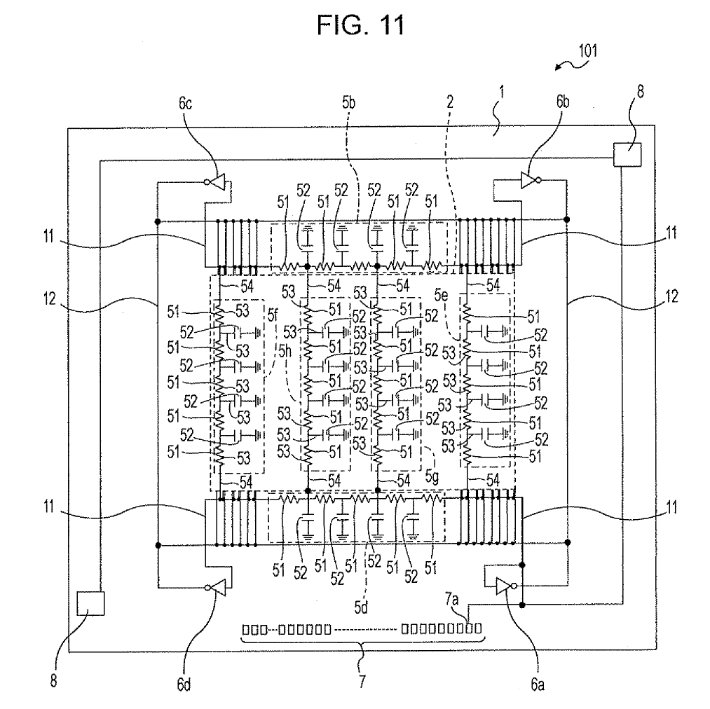

FIG. 10 is a plan view showing a display device according to a second embodiment of the invention. FIG. 11 is a circuit diagram of the display device according to the second embodiment of the invention. Next, a display device 101 of the second embodiment will be described with reference to FIGS. 10 and 11. Unlike the first embodiment, delay circuits 5e to 5h are provided in the display area 2 in the display device 101.

In the display device according to the second embodiment, as shown in FIGS. 10 and 11, the inverting circuits 6a to 6d are disposed at four corners of the rectangular display area 2 one by one, and the inverting circuits 6a and 6d (inverting circuits 6b and 6c) are connected by the signal lines 11 and the signal line 12. Note that a signal whose logic will be inverted by the corresponding one of the inverting circuits 6a to 6d is input to the signal line 11, and a signal whose logic is inverted by the corresponding one of the inverting circuits 6a to 6d is output to the signal line 12. Further, the delay circuits 5b is connected to the inverting circuits 6b and the inverting circuits 6c via the wirings 11. Further, the delay circuits 5d is connected to the inverting circuits 6a and the inverting circuits 6d via the wirings 11.

Herein, in the second embodiment, as shown in FIG. 11, the delay circuit 5e is provided in the display area 2. The delay circuit 5e is connected to the inverting circuit 6a and the inverting circuit 6b via wirings 54. Further the delay circuit 5f is provided in the display area 2. The delay circuit 5f is connected to the inverting circuit 6c and the inverting circuit 6d via wirings 54. Further the delay circuit 5g and the delay circuit 5h are provided to connect the delay circuit 5b and the delay circuit 5d. Herein, in the second embodiment, each of the delay circuits 5e to 5h formed in the display area 2 in which the pixels 14 are arranged among the delay circuits 5b, 5d, and 5e to 5h is constituted by the resistors 51 and the capacitors 52. Further, each of the delay circuits 5b and 5d formed outside the display area 2 among the delay circuits 5b, 5d, and 5e to 5h may be constituted by the resistors 51 and the capacitors 52, or may be constituted by an inverter or the like. Further, in the second embodiment, a sheet resistance of the wiring 53 constituting the resistors 51 and the capacitors 52 is larger than sheet resistances of the data lines 18 and 19 (see FIG. 3). Specifically, the sheet resistance of a material of the wiring 53 constituting the resistors 51 and the capacitors 52 is larger than the sheet resistance of a material of the data lines 18 and 19. Alternatively, the thickness of the wiring 53 constituting the resistors 51 and the capacitors 52 is thicker than the data lines 18 and 19. Further, in the second embodiment, each of the delay circuits 5b, 5d, and 5e to 5h constituted by the resistors 51 and the capacitors 52 have a same delay amount.

Note that the other structure of the second embodiment is the same as that of the first embodiment.

In the second embodiment, as described above, the inverting circuits 5e to 5h among the inverting circuits 5b, 5d, and 5e to 5h are formed in the display area 2 in which the plurality of pixels 14 are arranged. Accordingly, a planar size of the display device 2 can be reduced by sizes of the delay circuits 5e to 5h unlike the case where the delay circuits 5e to 5h are formed outside the display area 2.

Further, in the second embodiment, as described above, each of the delay circuits 5e to 5h formed in the display area 2 in which the plurality of pixels 14 are arranged among the delay circuits 5b, 5d, and 5e to 5h is constituted by the resistors 51 and the capacitors 52. Accordingly, the sizes of the delay circuits 5e to 5h can be easily reduced unlike the case where each of the delay circuits 5e to 5h is constituted by, for example, an inverter or the like. As a result, the delay circuits 5e to 5h can be easily formed in the display area 2 in which the plurality of pixels 14 are arranged.

Further, in the second embodiment, as described above, the resistance of the wiring 53 constituting the resistors 51 and the capacitors 52 is larger than the resistances of the data lines 18 and 19. Accordingly, delay of the signal /F output from the delay circuits 5b, 5d, and 5e to 5h can be easily performed with the wiring 53.

Further, in the second embodiment, as described above, each of the delay circuits 5b, 5d, and 5e to 5h have a same delay amount. Accordingly, a delay amount of the signal input to each inverting circuits 6a to 6d can be precisely adjusted unlike the case where delay amounts of the delay circuits 5b, 5d and 5e to 5h are varied.

Further, in the second embodiment, the adjacent inverting circuits 6a and 6b (inverting circuits 6c and 6d) are connected via the delay circuits 5e (delay circuit 5f) formed in the display area 2. Accordingly, unlike the case where each of the inverting circuits 6a to 6d is connected via the delay circuit formed outside the display area 2, it can be restrained that a planar size of the display device 101 is enlarged even when the delay circuit 5e (delay circuit 5f) is provided.

Note that the other effect of the second embodiment is the same as that of the first embodiment.

### Third Embodiment

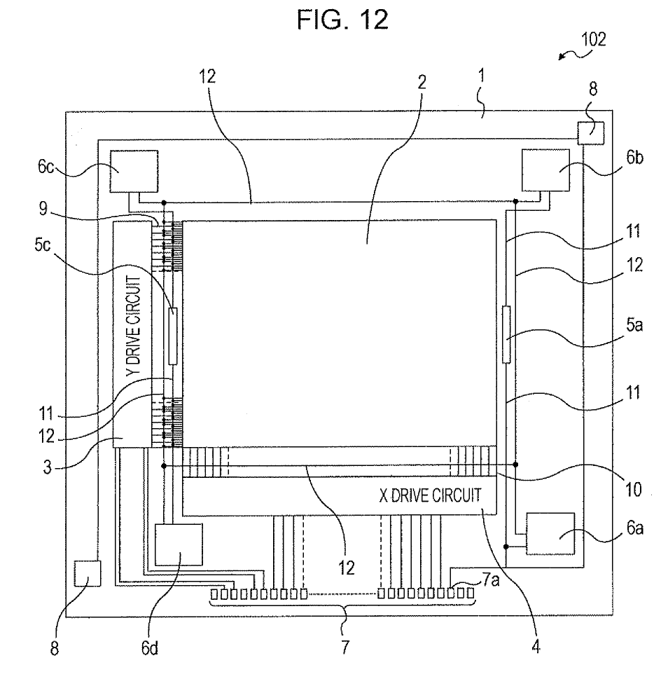

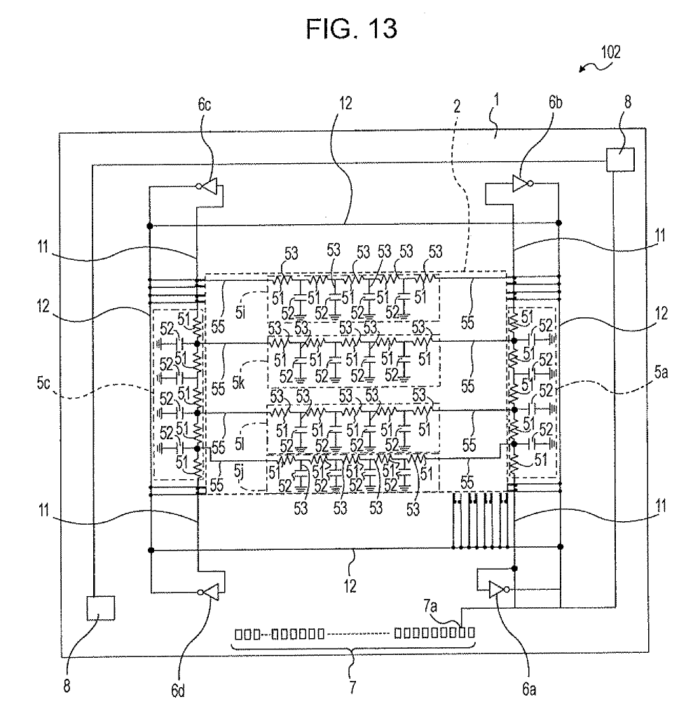

FIG. 12 is a plan view showing a display device according to a third embodiment of the invention. FIG. 13 is a circuit diagram of the display device according to the third embodiment. Next, a display device 102 of the third embodiment will be described with reference to FIGS. 12 and 13. Unlike the first embodiment, delay circuits 5i to 5l are provided in the display area 2 in the display device 102.

In the display device 102 according to the third embodiment, as shown in FIGS. 12 and 13, the inverting circuits 6a to 6d are disposed at four corners of the rectangular display area 2 one by one, and the inverting circuits 6a and 6b (inverting circuit 6c and 6d) are connected by the signal lines 11 and signal line 12. Note that a signal whose logic will be inverted by the corresponding one of the inverting circuits 6a to 6d is input to the signal line 11, and a signal whose logic is inverted by the corresponding one oh the inverting circuits 6a to 6d is output to the signal line 12. Further, the delay circuit 5a is connected to the inverting circuit 6a and the inverting circuit 6b via the signal lines 11. Further, the delay circuit 5c is connected to the inverting circuit 6c and the inverting circuit 6d via the signal lines 11.

Herein, in the third embodiment, as shown in FIG. 13, the delay circuit 5i is provided in the display area 2 so as to be connected to the inverting circuit 6b and the inverting circuit 6c via wirings 55, and the delay circuit 5j is provided in the display area 2 so as to be connected to the inverting circuit 6a and the inverting circuit 6d via wirings 55. Further, the delay circuit 5k and the delay circuit 5l are provided so as to connect the delay circuit 5a and the delay circuit 5c. Further, in the third embodiment, each of the delay circuits 5i to 5l formed in the display area 2 in which the pixels 14 are arranged among the delay circuit 5a, 5c, and 5i to 5l is constituted by the resistors 51 and the capacitors 52. Further, the delay circuit 5a and the delay circuit 5c formed outside the display area 2 among the delay circuit 5a, 5c, and 5i to 5l may be constituted by the resistors 51 and the capacitors 52, or may be constituted by an inverter or the like. Further, in the third embodiment, a sheet resistance of the wiring 53 constituting the resistors 51 and the capacitors 52 is larger than the resistances of the data lines 18 and 19 (see FIG. 13) Further, in the third embodiment, each of the delay circuits 5a, 5c, and 5i to 5l constituted by the resistors 51 and the capacitors 52 have a same delay amount.

Note that the other structure of the third embodiment is the same as that of the first embodiment.

Further, the effect of the third embodiment is the same as that of the second embodiment.

Note that it should be considered that the embodiments disclosed herein are illustrative in every respect, and that the invention is not limited thereto. The scope of the invention is not shown by the description of the embodiments but is shown by the scope of the claims. Further, the scope of the invention includes meaning equivalent to the scope of the claims as well as all changes in the scope of the claims.

For example, in the first to third embodiments, the example in which the SRAM 145 is provided in the pixel 14 is shown. However, the invention is not limited thereto and a DRAM may be provided therein,

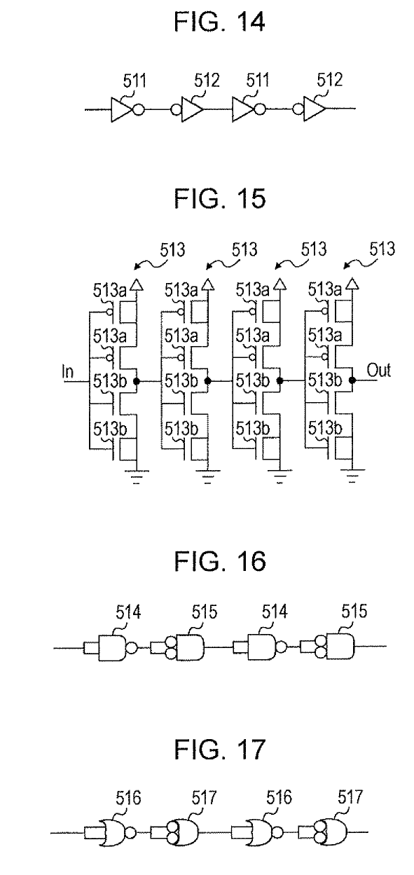

Further, in the first to third embodiments, an example is shown in which each of the delay circuits 5a to 5l is constituted by the resistors 51 and the capacitors 52. However, the invention is not limited thereto and as shown in a modification shown in FIG. 14, the delay circuit may be constituted by alternatively connecting two positive logic inverters 511 and two negative logic inverters 512.

Further, in the first to third embodiments, the example is shown in which each of the delay circuits 5a to 5l is constituted by the resistors 51 and the capacitors 52. However, the invention is not limited thereto, and as shown in a modification shown in FIG. 15, the delay circuit may be constituted by connecting inverters 513 constituted by two p-channel transistors 513a and two n-channel transistors 513b in series. Note that, the source and the drain of each of the p-channel transistors 513a connected to a power source of a high voltage and the n-channel transistors 513b grounded is connected.

Further in the first to third embodiments, the example is shown in which each of the delay circuits 5a to 5l is constituted by the resistors 51 and the capacitors 52. However, the invention is not limited to thereto, and as shown in a modification shown in FIG. 16, the delay circuit may be constituted by alternatively connecting two positive logic NAND circuits 514 and two negative logic NOR circuits 515.

Further, in the first to third embodiments, the example is shown in which each of the delay circuits 5a to 5l constitute by the resistors 51 and the capacitors 52. However, the invention is not limited thereto, and as shown in a modification shown in FIG. 17, the delay circuit may be constituted by alternatively connecting two positive logic NOR circuits 516 and two negative logic NAND circuits 517.

The entire disclosure of Japanese Patent Application No. 2007-289185, filed Nov. 7, 2007 is expressly incorporated by reference herein.

What is claimed is:

1. A display device comprising:
a plurality of pixels;
a plurality of inverting circuits each for generating a second electrical potential by inverting a first electrical potential supplied to a pixel electrode included in the pixel, each of the plurality of inverting circuits being connected to a power source at a high voltage side and a power source at a low voltage side; and
a delay circuit for delaying a signal input to the inverting circuit, the delay circuit being provided between the plurality of inverting circuits.

2. The display device according to claim 1, wherein
each of the first electrical potential and the second electrical potential is a pulse signal.

3. The display device according to claim 1, wherein
a plurality of the delay circuits are provided, and
at least a part of the plurality of delay circuits is formed in an area in which the plurality of pixels are arranged.

4. The display device according to claim 3, wherein
the area in which the plurality of pixels are arranged is a rectangular shape,
the plurality of inverting circuits includes four inverting circuits disposed at four corners of the rectangular area in which the plurality of pixels are arranged, and
two adjacent inverting circuits among the four inverting circuits are connected via one of the delay circuits formed in the area in which the plurality of pixels are arranged and the other two adjacent inverting circuit among the four inverting circuits are connected via another one of the delay circuits formed in the area in which the plurality of pixels are arranged.

5. The display device according to claim 3, wherein at least the delay circuit formed in the area in which the plurality of the pixels are arranged among the plurality of delay circuits is constituted by a resistor and a capacitor.

6. The display device according to claim 5, further comprising:
a wiring contained in the delay circuit formed in the area in which the plurality of the pixels are arranged; and
a data line for supplying data to the pixel, wherein
a sheet resistance of the wiring is larger than a sheet resistance of the data line.

7. The display device according to claim 1, wherein
a plurality of the delay circuits are provided, and
each of the plurality of delay circuits has a same delay amount.

8. The display device according to claim 1, wherein
the delay circuit includes an inverter.

9. The display device according to claim 1, wherein
the delay circuit includes at least any one of a NAND circuit and a NOR circuit.

10. The display device according to claim 1, wherein
a signal input to the inverting circuit is to be input to the pixel electrode and a common electrode of the pixel.

11. The display device according to claim 1, wherein
the pixel includes a storage element.

12. The display device according to claim 1, wherein
the inverting circuits and the delay circuit are formed on a substrate on which a semiconductor element constituting the pixel is formed.

13. An electronic apparatus comprising the display device according to claim 1.
